(19) United States
(12) Patent Application Publication
(10) Pub. No.: US 2009/0134587 A1
(43) Pub. Date: May 28, 2009

(54) High temperature negative creep gasket and manufacturing same

(76) Inventor: Anatoly Efremov, Albuquerque, NM (US)

Correspondence Address: ANATOLY EFREMOV, 9923 Osuna Rd., NE, Albuquerque, NM, 87111, US

(21) Appl. No.: 12/319,206

(22) Filed: Feb. 2, 2009

Related U.S. Application Data
(63) Continuation of application No. 11/405,722, filed on Apr. 18, 2006.

(51) Int. Cl. F16J 15/08

(52) U.S. Cl. 277/627

(57) ABSTRACT

A negative creep gasket with corrugated core of high temperature Shape Memory Alloy (SMA) provides multiple leak-tight, automatic and continuous seal between the flanges of Bolted Flanged Connection (BFC) used in plant/piping systems that operate under critical conditions including a variety of high operating temperatures within the range of from 300° C. to 1120° C. The specific high operating temperature of the BFC is in the temperature interval of reverse martensitic phase transformation from martensite to austenite of the SMA from which gasket corrugated core is manufactured. The gasket corrugated core is shape-memorized to the “swelling” during gasket manufacturing and bolt preload force application, and a free gasket “swelling” due to shape recovery of initial configuration of the core is constrained by rigid flanges at high operating temperature of the BFC that leads to appearance of reactive shape-recovering stresses having direction inverse to the direction of operating creep of the gasket. The manufacturing of the high temperature negative creep gasket is disclosed.

### CROSS REFERENCE TO RELATED APPLICATIONS

This Patent Application is a continuation of earlier now abandoned patent application Ser. No. 10/834955 filed on Apr. 30, 2004, as well as Provisional Patent Application No. 60/671,419 filed on Apr. 15, 2005 and patent application Ser. No. 11/405,722 filed on Apr. 18, 2006.

### FEDERALLY SPONSORED RESEARCH

Not Applicable

### SEQUENCE LISTING OR PROGRAM

Not Applicable

### BACKGROUND OF THE INVENTION—FIELD OF THE INVENTION

The present invention relates to novel type of gaskets displaying “negative creep” effect and providing automatic and continuous leak-tight multiple seal between adjacent flanges of Bolted Flanged Connections (BFCs) used in pressure vessels, piping systems, and other engineering structures that operate under critical conditions of extended action of a variety of high operating temperatures and internal pressures.

### BACKGROUND OF THE INVENTION—PRIOR ART

Bolted Flanged Connections (BFCs) with gaskets as sealing elements used in plant/piping systems of petroleum refining, petrochemicals, fossil fuel and nuclear power generation, aerospace, automobile, submarine shipbuilding, and other industries experience operating leakages due to loss of leak tightness of gasketed joints. The operating leakage consequences are difficult to estimate, but the possible fires, explosions and environmental pollution are close relatives of the leakage events which lead to enormous material and financial losses due to plant shutdowns, production penalties, maintenance rework activities, equipment replacement or repair, and so on.

One of the main reasons of the leakages is a creep of the gaskets that operate under critical conditions including a variety of high operating temperatures and high internal pressures. Many thousands of patent documents concerning to gasket materials and gasket styles underline the importance of operating leakage problem, and simultaneously they testify that previous approaches proposing regular “excellent” gasket material or sophisticated gasket style cannot guarantee the safe and extended service life of critical engineering structures containing the BFCs with gasketed joints.

One of the popular ways to limit plant/piping leakages consists in the use of special techniques to create a multiple seal between adjacent flanges of the BFCs. Doty, who proposed a metallic gasket having a corrugated shape capable to create a multiple contact between corrugation and flange surfaces, was the first disclosed the principal idea of this approach in the oldest U.S. Pat. No. 2,223,88. This idea was developed in next US Patent Documents No. 854135 by Whittemore and No. 922130 by Goetze. First of them discloses a fabric gasket with a corrugated transversally-stiff metallic core, and second describes a gasket comprising two-layer metallic disc that is formed of a series of annular concentric corrugations with asbestos corrugated packaging between metallic layers of the disc. In last case the metallic corrugations are intended to form solid supports for asbestos packing that can provide a fluid-tight seal because the packing material is held firmly and effectively against the lateral movement upon the metallic retaining disc of the packing.

The idea of gasket corrugation continues to be used for more than one century but new modern approaches consist in application of corrugated metallic gasket cores which, being deformed by gasket seating stress due to bolt preload can provide spring forces between corrugation and adjacent flange surfaces. These spring forces create a multiple fluid-locked barriers capable of ensuring a necessary leak-tight joint. The multiple annular seal may be obtained with gasket comprising some concentric, separate, radially spaced metallic corrugations with protective envelope manufactured from materials convenient for critical process conditions such as high temperatures and internal pressures, oxidation, fire events, chemical influences, and the like. The expanded layers of protective materials maintain the contour of the functional corrugations.

The US Patent Documents Nos. 1030055 to Darlington, 2006381 to Bailey, 3595589 to Henderson, 4234638 to Yamazoe et al., 4485138 to Yamamoto et al., 4676515 to Cobb, 4705278 to Locasius et al., 4795174 to Whitlow, 5421594 to Becerra, 5556113 to Amorese et al., 5558347 to Nicholson, 6092811 to Bojarczuk et al., and Foreign Patent Documents Nos. FR 118630, GB2229047, RU2016305 describe the practical approaches to create gasket materials and gaskets providing multiple seal by utilizing the gasket cores of functionally corrugated metals encapsulated by protective envelopes.

All these inventions disclose approaches to form corrugated gasket cores that are preferably constructed of similar metals such as aluminum, brass, copper or stainless steel (e. g., 304, 309, 310, 316, 321, 347, 410, 430, 501). The further selection of metal depends upon the metallurgy of the flanges to be sealed, and on the degree of chemical resistance desired from the metal gasket core. This range includes Alloy 20, Hasalloy B and C, Inconel 600, Incolloy 825, Monel, and others.

It is well known that all these metals used in corrugated core fabrication experience inevitable creep under conditions of a variety of high operating temperatures and load-induced stresses, so that the spring feature and trapping action of corrugated compressed core will be inevitable decreased during long exposure to the load and thermal influences. The creep of gasket materials and compressed gaskets is common characteristics of all existing approaches that try to improve a leak tightness of gasketed joints used in BFCs. This feature defines a “passive” behavior of gasket materials and gasket styles under critical operating conditions that inevitable leads to routine operating leakages.

The next two patent documents are closest to present invention and relate to application of Shape Memory Alloy (SMA).

The U.S. Pat. No. 3,971,566 to Levinsohn discloses a metallic V-ring sealing member with single convex surface oriented in the radial direction perpendicularly to the axis of tubular hydraulic system. The V-ring is fabricated from a metal capable of undergoing an austenitic to martensitic state change upon cooling below a transition temperature, said temperature being below about −60° C., and of undergoing a further transformation from martensitic to austenitic state upon warming from below said temperature to a temperature of less than the operating temperature of the system that is within the range of from about −54° C. to about 232° C. These temperatures define the transition temperature range of metals from which sealing members of the invention may be fabricated. The metal from which the V-ring is manufactured relates to SMA, and after axial compressing of the V-ring by a screwing adaptor at temperature below than temperature of martensitic state of the SMA, the opposed free ends of the V-ring will be almost bridged and hydraulic system may be sealed by warming the V-ring to temperature corresponding to its austenitic state. The sealing effect is similar to a thrust, and it is provided by two opposed ends of the V-ring which try to recover their initial undeformed position at temperature of austenitic state of the SMA that is lower than operating temperature of the system.

The US Patent Application No. 2002/0187020 to Julien discloses a lock washer for locking a threaded fastener from loosening under vibration. The lock washer has a corrugated configuration with central hole that receives a bolt shank. The lock washer is made of either one of two types of Nitinol: Superelastic Type 55 Nitinol SMA that is having a transition temperature above about 100° C. or ultraelastic Type 60 Nitinol SMA that is having transition temperature of about 30° C.-85° C., so that they remain in martensitic state in all normal conditions of use. Type 60 Nitinol has not significant elastic properties at all. Washers made from Type 55 Nitinol provide large elastic properties while attenuating the input force. The martensitic Nitinol initially yields during torquing of the nut to allow the nut to indent itself slightly into the lock washer. The martensitic Nitinol causes a transformation into stress-induced martensite due to indentation of the nut. The stress-induced martensite is strong and elastic to resist further deformation and also exerts a preload on the bolt shank. The nut, indented into the lock washer, strongly resists turning under vibration, which effect is further enhanced by the vibration absorbing characteristics of the Nitinol. However, the ability of lock washer to provide a seal between the nut and the adjacent structural member described by author cannot be physically realized due to inevitable leakage through the central hole of the washer and threaded bolt shank. Finally, the author did not include this unrealizable feature of the lock washer into the claims.

The present invention discloses a novel type of the gaskets based on a new sealing technology described for the first time by U.S. patent application Ser. No. 10/834,955 as a “negative creep” effect (“swelling”) that provides an “active” resistance of the gaskets to their operating creep. This approach uses the feature of shape recovery of the gasket corrugated core that is manufactured from advanced high temperature SMAs having temperature interval of reverse martensitic phase transformation from martensite to austenite that includes high operating temperature of the BFC.

### BACKGROUND OF THE INVENTION—OBJECTS AND ADVANTAGES

It is, therefore, a primary object of the present invention to provide a creep free gasket based on “negative creep” effect (“swelling”) of the gasket corrugated core manufactured from high temperature SMA having temperature interval of reverse martensitic phase transformation from martensite to austenite that includes the high operating temperature of the assembly.

The next object of the invention is to provide the gasket with corrugated core of high temperature SMA. The gasket corrugated core has a multiple convex-concave configuration that is obtained from flat sheets or flat strips while manufacturing the corrugation. The flat sheets or flat strips may have a plurality forms including annular, rectangular, ellipsoidal, and others. The gasket corrugation is formed in a press between two dies at initial temperature below the temperature of direct martensitic phase transformation from austenite to martensite of SMA followed by constrained continuous aging of rigidly fixed corrugation at temperature significantly higher than temperature of reverse martensitic phase transformation from martensite to austenite of SMA. The gasket corrugated core is then released from rigid fixation at initial temperature below the temperature of direct martensitic phase transformation of SMA.

The gasket corrugated core is now compressed in a press at the same initial temperature to obtain initial deformed configuration. This process of gasket deformation corresponds to stress-induced martensite formation. In this way gasket corrugated core will be shape-memorized to the “swelling”, and gasket corrugation may be further encapsulated by protective envelope manufactured from materials convenient for specific process conditions such as possible fires, oxidation, chemical influences, and others.

It is another object of the invention to provide the gasket with corrugated core of high temperature SMA that is additionally shape-memorized to the “swelling” being deformed by bolt preload force at temperature of BFC's assemblage procedure that is lower than temperature of martensite state of the SMA. The finally deformed gasket corrugation will try to recover its initial undeformed corrugated shape at high operating temperature of the assembly but this shape recovery (“swelling”) will be blocked by rigid flanges with appearance of reactive shape-recovering stresses between the deformed corrugation and flanges. The shape-recovering stresses have direction inverse to the direction of operating creep of the gasket that defines the “negative creep” effect and ensures multiple leak-tight, automatic, reliable and continuous seal between adjacent flanges.

A most important advantage of the present invention is a novel type of the gaskets with corrugated core of high temperature SMA that is quite different from any conventional ones because the novel gaskets display unprecedented “negative creep” effect at high operating temperature of the BFC that defines their active resistance to operating creep.

Another advantage of the present invention consists in the use of reactive shape-recovering stresses generated by multiple gasket corrugation deformed by bolt preload force while constrained shape recovery of initial undeformed corrugation at high operating temperature of the BFC. The reactive shape-recovering stresses have direction inverse to the direction of operating creep of the gasket providing multiple leak-tight, automatic, reliable and continuous seal between the flange surfaces due to multiple strong barriers against operating leakages that ensure safe and extended service life of the BFCs used in critical engineering structures.

### SUMMARY OF THE INVENTION

In accordance with the present invention, a gasket of the BFC comprises a corrugated core manufactured from high temperature SMA having temperature interval of reverse martensitic phase transformation from martensite to austenite that includes high operating temperature of the BFC. The gasket corrugated core of high temperature SMA is obtained from flat sheets or flat strips by compressing them in a press between two dies at initial temperature below the temperature of martensite state of the SMA. The corrugation obtained is then subjected to continuous constrained aging at temperature significantly higher than temperature of reverse martensitic phase transformation from martensite to austenite of the SMA followed by release from fixation at initial temperature below the temperature of martensite state of the SMA.

The gasket corrugated core of SMA is compressed in a press between two flat dies at the same initial temperature receiving some quantity of residual contraction that corresponds to stress-induced martensite formation. After this procedure the deformed gasket core will be shape-memorized to the “swelling” that will appear at high operating temperature of the BFC resulting from shape recovery of initial undeformed configuration of the corrugated core. The gasket core is then encapsulated by protective envelope forming a ready to use gasket.

This fabricated gasket is then placed between two flanges of the BFC and additionally compressed by bolt preload force receiving some additional contraction. The gasket “swelling” will then be blocked by rigid flanges at high operating temperature of the BFC resulting in appearance of reactive shape-recovering stresses between the deformed gasket corrugation and rigid flanges due to constrained recovery of initial undeformed shape of the gasket corrugation. The reactive shape-recovering stresses have direction inverse to the direction of operating creep of the gasket that defines the “negative creep” of the gasket providing multiple leak-tight, automatic, reliable and continuous seal between adjacent flanges.

Further brief description of applied drawings followed by detailed description of the invention is intended to provide a basis for understanding the nature and character of the present invention and to explain the main principles and operation of presented high temperature “negative creep” gasket.

### BRIEF DESCRIPTION OF THE DRAWINGS

FIG. 1 is a cross-sectional view of an annular gasket corrugated core of high temperature SMA obtained after continuous constrained aging at temperature significantly greater than temperature of reverse martensitic phase transformation of the SMA.

FIG. 2 is a cross-sectional view of the “negative creep” annular gasket with protective envelope obtained after initial compression of the corrugated core shown in FIG. 1 at temperature lower than temperature of direct martensitic phase transformation from austenite to martensite of the SMA.

FIG. 3 is a cross-sectional view of the “negative creep” annular gasket shown in FIG. 2 placed between two rigid flanges of BFC and compressed by bolt preload force at temperature of assemblage procedure of the BFC.

FIG. 4 is a cross-sectional view of compressed “negative creep” annular gasket shown in FIG. 3 subjected to high operating temperature “T” of the assembly.

### DETAILED DESCRIPTION OF THE INVENTION

Operating creep of any conventionally used corrugated gasket cores relates to “passive” behavior of the gaskets under critical operating conditions that leads to the leakages because of gasket thickness loss due to time-temperature aging effect of the core metal compressed by bolt preload.

The present invention is based on “negative creep” effect displayed by gasket corrugated core of high temperature SMA under critical operating conditions including extended influence of high operating temperature and high internal pressure. The disclosed novel type of the gaskets relates to practical application of a new sealing philosophy based on “active” resistance of the gaskets to conventional operating creep.

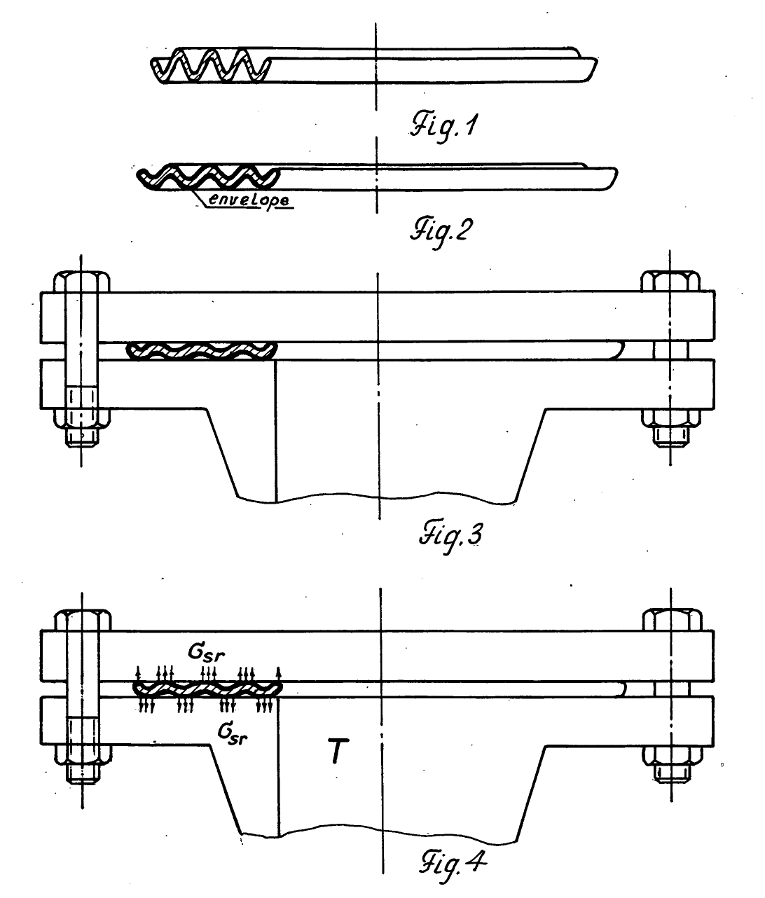

The annular gasket corrugated core is shown in FIG. 1. The core is manufactured from high temperature SMAs having temperature interval of reverse martensitic phase transformation from martensite to austenite that includes high operating temperature of the BFCs. The gasket corrugated core may be fabricated from flat sheets or flat strips of high temperature SMA convenient for specific process temperatures. For example, to fabricate the gasket annular core with multiple concentric corrugations from flat sheet or strip it is needed to place it under press having specific profile convenient to form a necessary gasket corrugation under temperature of martensite state of the SMA. The corrugation may have a plurality profiles such as sinusoidal, U-inverted U, V-inverted V, triangular (as shown in FIG. 1), or other similar shapes, or combination thereof. The corrugation is then rigidly fixed and subjected to continuous aging at temperature significantly higher than temperature of austenite formation of the SMA. After convenient time of aging the corrugation is released from fixation at temperature below the temperature of martensite formation of the SMA obtaining necessary initial corrugated shape of the gasket core. The obtained gasket core will “remember” this initial corrugated shape shown in FIG. 1 The high temperatures SMAs from which the gasket corrugation is manufactured have temperatures of reverse martensitic phase transformation from martensite to austenite within the range of from 300° C. to 1120° C. These SMAs are the compositions of Ni—Mn—Ga, Ni—Ti—Pd, Ti—Pd, Ni—Ti—Pt, Ti—Ni—Hf, Ti—Ni—Zr and some others (for lower and middle values of the temperature range), and Nb—Rb—Fe, Nb—Rb and Ta—Rb (for upper values of the temperature range). This temperature range corresponds to critical plant/piping systems used in petroleum refining, petrochemicals, aerospace, fossil fuel and nuclear power generation, and other industries.

The gasket corrugated core is then placed in press between two flat dies and compressed at temperature below the temperature of martensite formation to obtain some residual contraction that corresponds to stress-induced martensite formation. After this procedure the deformed gasket corrugation is encapsulated by protective envelope manufactured from materials convenient for specific process conditions such as possible fires, oxidation, chemical influences, and others forming the “negative creep” gasket. The “negative creep” gasket that is ready to use is shown in FIG. 2.

The gasket is then placed between the rigid flanges of the BFC and additionally compressed by clamping force due to bolt preload at temperature of assemblage procedure as shown in FIG. 3. This temperature is below than final temperature of martensite formation of the SMA, and gasket compression corresponds to formation of stress-induced martensite described above. The deformed gasket corrugated core will then try to recover its initial undeformed shape at high operating temperature “T” of the BFC that is in the range of temperature of reverse martensitic phase transformation from martensite to austenite of the SMA. This shape recovery (“swelling”) will be blocked by rigid flanges providing constrained shape recovery with appearance of reactive shape-recovering stresses “σₛᵣ” as shown in FIG. 4. The reactive shape-recovering stresses have direction inverse to the direction of operating creep of the gasket that corresponds to “negative creep” effect. The reactive shape-recovering stresses create a multiple leak-tight seal between the gasket and flanges providing safe and extended service life of the BFCs used in critical “temperature-internal pressure” operating conditions.

### CONCLUSION, RAMIFICATION AND SCOPE

Presented novel type of gasket with corrugated core of high temperature SMAs is shape-memorized to the “swelling” being deformed while manufacturing followed by compression with clamping force due to bolt preload at temperature of assemblage procedure. It then displays a “negative creep” effect resulting in reactive shape-recovering stresses that appear between the rigid flanges and deformed corrugation at high operating temperature of the BFC that is in the range of temperature interval of reverse martensitic phase transformation from martensite to austenite of the SMA from which the gasket corrugated core is manufactured. The reactive shape-recovering stresses are generated by deformed gasket corrugation when it tries to recover its undeformed initial shape at high operating temperature of the BFC. This shape recovery (“swelling”) is blocked by rigid flanges, and resulting reactive shape-recovering stresses have direction inverse to the direction of operating creep of the gasket corresponding to “negative creep” effect of the gasket.

The “negative creep” effect of novel type of gasket is a basis to limit or completely exclude plant/piping leakages providing multiple leak-tight, automatic and continuous seal between adjacent flanges of the BFCs used in engineering structures that operate under critical operating conditions including high internal pressures and a variety of high operating temperatures.

The “negative creep” gasket will find a large applicability in critical plant/piping systems used in petroleum refining, petrochemicals, aerospace, submarine shipbuilding, and other industries. The scope of application of the “negative creep” gaskets is limited by some existing types of high temperatures SMAs having relatively high cost or low plasticity, but inevitable progress in material science will provide all necessary SMAs to cover the needs of modern critical industries.

What is claimed is:

1. A gasket for a leak-tight sealing of the flanges of Bolted Flanged Connection (BFC), the gasket containing a corrugated core manufactured from high temperature Shape Memory Alloy (SMA) while deforming flat sheet or flat strip of said SMA at temperature below the final temperature of martensite formation of said SMA to obtain said corrugated core followed by continuous constrained aging of rigidly fixed said corrugated core at temperature significantly higher than final temperature of austenite formation of said SMA with subsequent release of said corrugated core from rigid fixation at temperature below the final temperature of martensite formation of said SMA.

2. The gasket according to claim 1 wherein said SMA has temperature interval of reverse martensitic phase transformation from martensite to austenite that includes the high operating temperature of said BFC.

3. The gasket according to claim 1 wherein said gasket has annular, rectangular, ellipsoidal, or other forms.

4. The gasket according to claim 1 wherein said corrugated core is manufactured from said high temperature SMAs such as compositions of Ni—Mn—Ga, Ni—Ti—Pd, Ti—Pd, Ni—Ti—Pt, Ti—Ni—Hf, Ti—Ni—Zr, Nb—Rb—Fe, Nb—Rb and Ta—Rb having temperature interval of reverse martensitic phase transformation from martensite to austenite within the range from 300° C. to 1120° C. This temperature range corresponds to operating temperatures of critical plant/piping systems used in petroleum refining, petrochemicals, aerospace, fossil fuel and nuclear power generation, and other industries.

5. The gasket according to claim 1 wherein said corrugated core has plurality profiles including U-inverted U, V-inverted V, sinusoidal, triangular, rectangular, or others similar shapes, or combination thereof.

6. The gasket according to claim 1 wherein said corrugated core of said high temperature SMA is shape-memorized to the “swelling” while compressing said corrugated core in a press at temperature below the final temperature of martensite formation of said SMA to obtain some quantity of residual contraction corresponding to stress-induced martensite formation.

7. The gasket according to claim 6 wherein said corrugated core of said high temperature SMA being compressed in a press at said temperature below the final temperature of martensite formation is then encapsulated by the protective envelope manufactured from materials convenient for specific operating conditions of said BFC such as fires, oxidations, chemical influences, and others.

8. The gasket according to claim 7 wherein said gasket with corrugated core of said high temperature SMA being placed between rigid flanges of the BFC is shape-memorized to the constrained “swelling” while compressing said gasket with a clamping force due to bolt preload at temperature of BFC's assemblage procedure that is below the final temperature of martensite formation of said high temperature SMA.

9. The gasket according to claim 8 wherein said constrained “swelling” results in reactive-shape recovering stresses which appear between the compressed said corrugated core and flange faces of the BFC at high operating temperature of said BFC, said reactive shape-recovering stresses have direction inverse to the direction of operating creep of the gasket and create multiple leak-tight seal between the gasket and flanges of the BFC.
